(19) United States
(12) Patent Application Publication
(10) Pub. No.: US 2021/0011826 A1
(43) Pub. Date: Jan. 14, 2021

(54) Flattened Historical Material Extracts

(71) Applicant: Code 42 Software, Inc., Minneapolis, MN (US)

(72) Inventor: Peter John Lindquist, St. Paul, MN (US)

(21) Appl. No.: 16/509,877

(22) Filed: Jul. 12, 2019

(51) Int. Cl. G06F 11/30; G06F 16/18; G06F 16/185; G06F 16/14; G06F 16/16; G06F 11/34

(52) U.S. Cl. CPC G06F 11/3075; G06F 16/1873; G06F 11/3409; G06F 16/156; G06F 16/164; G06F 16/185

(57) ABSTRACT

A system to generate historical usage data of a computing resource includes a module is configured to use at least one processor of the system to receive a query including a target and a time window and to retrieve historical file system data from backups of computing resources, where the historical file system data includes a file system object that was processed by the target during the time window. The module is further configured to use at least one processor of the system to generate historical usage data by converting the historical file system data to a temporally flat format that preserves a provenance of the file system object and to store the historical usage in a hierarchical data structure. The module is additionally configured to use at least one processor of the system to provide the hierarchical data structure in a response to the received query.

### TECHNICAL FIELD

Embodiments of the present disclosure relate generally to computing systems, more particularly, but not by way of limitation, to generating historical extracts of persisted artifacts in computing systems.

### BACKGROUND

Backup and restore systems include software application, computing servers, and storage systems, or other devices that operate to capture and preserve block level or file level data for computing resources. Corporations, firms, and other institutions (hereinafter, “business entities”) use these backup and recovery systems to protect their data, software, or other digital intellectual property assets from hardware failure, to support machine migration operations, or to mitigate data availability issues caused by user error or mismanagement. In each of these use cases, a backup and restore system can use preserved data to provide a business entity a version of their data, software, or other digital intellectual property assets from a specific point in time. Such preserved data include storage device images, snapshots, or other specific point in time versions of data that is modified or manipulated by actions of individual users of a computing resource. Such preserved data can also include metadata associated with such actions, such as discussed in United States (U.S.) patent application 16/360,273, which is titled “FORENSIC FILE SERVICE” and is hereby incorporated by reference. Collectively, such preserved data can provide insights into the potential authorized or unauthored use of data that is available to a computing resource.

### BRIEF DESCRIPTION OF THE DRAWINGS

Various ones of the appended drawings merely illustrate example examples of the present disclosure and cannot be considered as limiting its scope.

FIG. 1 illustrates a block diagram of an example of a system 100 for generating computing resource usage data from preserved point in time data, according to some examples of the present disclosure.

FIG. 2 illustrates block diagram of an example of elements of data structure for storing computing resource usage data, according to some examples of the present disclosure.

FIG. 3 illustrates a block diagram of an example of components of a system for generating computing resource usage data for a target user or computing resource, according to some examples of the present disclosure.

FIG. 4 illustrates an example of an implementation of a data structure 400 for storing computing resource usage data, according to some examples of the present disclosure.

FIG. 5 illustrates an example of a process 500 for generating computing resource usage data of a target user or a target computing resource, according to some examples of the present disclosure.

FIG. 6 illustrates a diagrammatic representation of a machine in the form of a computer system within which a set of instructions may be executed for causing the machine to perform any one or more of the methodologies discussed herein, according to an example.

### DETAILED DESCRIPTION

Investigators can be tasked with analyzing the computing resource usage of a particular employee or other user (hereinafter, “user”), such as in situations where there is reason to suspect that such computing resource usage can exceed authority delegated to a user or may be harmful to an owner of the computing resource. In an example, an employee who has given notification that he intends to leave a business entity might be suspected of misappropriating data, software, or other digital intellectual property or digital assets (hereinafter, “protected data”) prior to such announcement, or their official departure. Such misappropriation can include the unauthorized copying, printing, transmitting, or processing of such protected data. In view of this, a business entity can task an investigator with determining the likelihood that such misappropriation did in fact occur. The investigator in this example and other scenarios can gain insights into a whether such misappropriation has occurred by analyzing all available data associated with a user's access to, or use of, computing resources that can access the protected data of a business entity. Such computing resource usage data can include copies one or more versions of user-level files, system-level files or other data objects, that were created, modified, or deleted within a time window. Such computing resource usage data can also include any data, metadata, or other computing artifact that is useful for useful for determining actions that were performed by a user within a time window.

Current investigation techniques of extracting and analyzing computing resource usage data can require physical or electronic access to the targeted computing. An investigator that has such access, however, usually only has a view of the state of the computing resource at a single point in time (e.g., the current point in time). Accordingly, it can be difficult for the investigator to determine computing resource usage data that was generated by user activities that were performed over a period or window of time. The computing resource point in time backup data (hereinafter, “point in time data”) that is preserved by backup and restore systems can provide insight into the activities or actions associated with a user of a computing resource over a specified window of time. Such backup data, however, can include large compressed records, such as storage device images or snapshots, that are difficult or computationally impractical for an investigator to process and extract useful insights.

Aspects of the present disclosure are based on the inventors' recognition that backup and restore systems can be enhanced to support investigations into computing resource usage, such as by using preserved point-in-time data to generate, or provide, historical computing resource usage data (hereinafter, “computing resource usage data” or “usage data”) that is indicative of computing resource usage by a target over a specified window of time. Such computing resource usage data can include any information that is indicative of data that was under the control of a user during the specified window of time. Such computing resource usage data can, for example, include metadata, such as forensic filesystem data, that is derived from, or indicative of, computing operations performed by the user within the time window. In another example, such computing resource usage data can include temporally flat file system data, such as copies of one or more versions of file system objects, such as files or binary large objects (BLOG), that were created, modified, or deleted within the window.

File system data can include one or more versions of a filesystem objects that are generated at different points in time (e.g., during different backup events). Such file system data can be converted to a temporally flat format by modifying or enhancing one or more versions of a file system object to remove or eliminate the influence of time in their storage or presentation so as to enable two or more versions to be concurrently stored or presented in the same storage element (e.g., in the same directory of folder of a filesystem data structure). In an example, such modification can include augmenting or modifying an identifier of version of a filesystem object, such as to cause a first version of the file system object to have a different identifier than the second version of the file system object. Such enhancements can enable disparate versions a data object, and associated metadata, that are generated at different points in time to be presented or stored at the same partition of hierarchical data structure. Such enhancements can also include restoring data objects that were recycled or deleted during a specified time window.

Aspects of the present disclosure are directed to techniques (e.g., systems, methods, and machine-readable storage mediums) for generating, or extracting, historical computing resource usage data (hereinafter, “historical usage data”) from preserved point in time data and providing such data in self-contained (e.g., existing independently of any specific computing hardware or computing resource) hierarchical data structure. Such techniques can include receiving a query for usage data that is associated with the computing resource usage activities of a target (e.g., a computing resource or a user associated with a computing resource) during an indicated window of time. Such techniques also include retrieving (e.g., extracting) file system data from a historical data set, such as point in time data or forensic file service metadata stored by a backup and restore system, and modifying or enhancing the retrieved file system data to generate the usage data. Such modifications can include converting the file system data to a temporally flat format while preserving the provenance of converted file system objects. Such modification can also include generating metadata this is useful for determining the provenance of the filesystem object. Such techniques further include storing the usage data and associated metadata in the self-contained hierarchical data structure, such as provide a temporally flat view of computing resource usage data for the target during the specified window of time.

The techniques described herein provide an enhanced data set in a self-contained hierarchical data structure that can provide a view, or copy, of the all usage activities (e.g., computing events, operations performed, data accessed) of associated with a target within a window of time. Such an enhanced dataset is not limited to data collected at a specific point in time. Rather, the enhanced dataset can include data collected at all points in time within a time window. Presentation of such enhanced data in a temporally flat data format enables the data set to be analyzed or manipulated using techniques that were previously prohibitively expensive with respect to time, cost, and computing power.

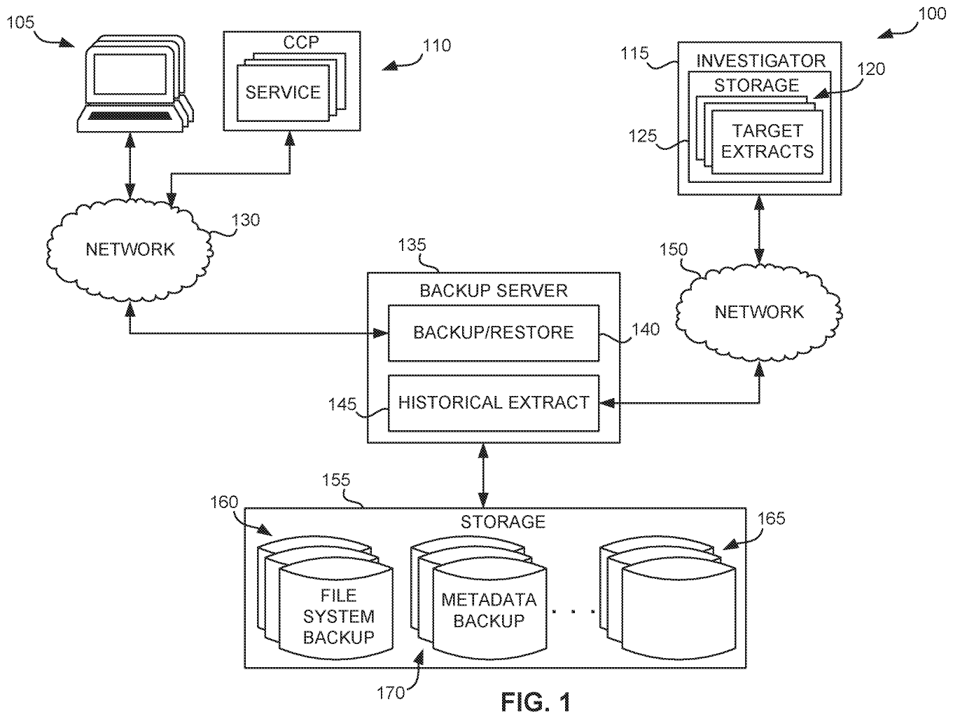

Turning now to the figures, FIG. 1 illustrates a block diagram of an example of a system 100 for generating computing resource usage data from preserved point in time data (e.g., generating historical extracts of persisted artifacts of a computing resource), according to some examples of the present disclosure. Such usage data any files, metadata, or other computing resource usage data that is preserved by a computing system, such as a backup and restore system. In some examples, such usage data can be extracted from a data repository (e.g., a historical data set), such as storage system images, snapshots, or other point in time backups stored by a backup and restore system. The system 100 can include a backup server 135 and a storage system 155. In an example, the system 100 includes one or more client computing resources (e.g., endpoints) 105 and 110. In another example, the system 100 can include a investigating computing resource 115. Elements of the system 100 can communicate electronically, such as though data communication network 130 or 150.

The backup server 135 and the storage system 155 are an example of a backup and restore system. The backup server 135 can include a backup/restore server application 140 (hereinafter, “backup application 140”) and a historical extract application 145, while the storage system 155 can include one or more data repositories, such as file system backup repository 160, a metadata backup repository 170, or any other data backup repository 165.

The file system backup repository 160 can include one or more block level backup, such as a storage device image or snapshot, or file level backup that represent user or system data stored on one or more of the computing resources 105 or 110 at one or more points in time. Such backups can be captured periodically or according to a specified criteria, such as after the creation of a new file system object (e.g., a file or directory) or after the modification of an existing filesystem object. Such backups can be stored in an indexable database as one or more compressed data objects.

The metadata backup repository 170 can include backups of any metadata that is generated or captured during operation of the computing resources 105 or 110. Such metadata can include data that is indicative of one or more filesystem event (e.g., events generated based on any operation that creates, modifies, or deletes a filesystem element) or operation to access, use, or modify a hardware or software resource of the computing resources 105 or 110. Such metadata can be generated or captured continuously during the operation of the computing resource 105 or 110, and can be contemporaneously backed up, backed up periodically, or backed up according to a specified criteria.

The computing resources 105 or 110 can include any computing system or endpoint device, such as a user computing device, computing server, or a network-based or hosted computing environment, such as a virtual computing environment on cloud computing platform. Such computing resources 105 or 110 can be configured (e.g., programmed) with a client application to generate point in time backups of file system objects and provide such backups to the backup server 135. Such computing resources 105 or 110 can also be configured with a software application to detect operations executed on a filesystem element and generate filesystem events (e.g., forensic filesystem events) based on the detected operations. The computing resources 105 or 110 can also include a computing environment, or a partition of a computing environment, that is allocated to a user of computing system.

The backup application 140 can be configured to manage point in time backup data that is received periodically or asynchronously (e.g., according to a criteria), such as from the client computing resources 105 or 110. Such management can include receiving point in time backup data (e.g., filesystem backup data or metadata backup data) from a client backup application executing on client computing resources 105 or 110 and storing such data in one or more data repositories of the storage system 155. Such management can also include receiving, and responding to, data restoration requests from the client computing resources 105 or 110. Responding to such requests can include retrieving one or more point in time backups from the storage system 155 and transmitting such backups to a requesting computing resource. In an example, responding to such requests can include processing compressed data in a backup, such as to retrieve one or more file system objects, or metadata.

The historical extract application 145 can be configured to process or service queries for usage, such as by receiving, and responding to, one or more queries for usage data for a target user or computing resource within an indicated window of time. Such query can be received from any computing resource that is coupled to the backup server 135, such as investigating computing resource 115.

A query for usage data can include an identifier of a target user or a target computing resource. A query that includes an identifier of a target user can cause the historical extract application 145 to extract usage data that from the point in time backups of any computing resource which the user accessed within an indicated time window. In an example, a query includes a request for historical computing resource usage data for user JOHN DOE within a two-month window from March 1 to April 30 within a specified year. Such query can cause usage data to be extracted from the backups of any of the computing resources 105 or 110 on which JOHN DOE had an account or performed any other form of identifiable (e.g., traceable) access between March 1 and April 30 of the specified year. A query that includes an identifier on a target computing resource can cause the historical extract application 145 to extract usage data associated with any user of the computing resource. A query that includes both an identifier of a user and an identifier of target computing resource can cause the historical extract application 145 to extract usage data associated with the target user of the target computing resource.

The queried computing resource usage data can include any usage data of the user that was preserved during the time window specified in the query.

The indicated time window can include a span of time in any format, such as one or more cycles, ticks, minutes, hours, days, weeks, months, years, etc. In an example, the window of time can be specified relative to a calendar date.

The historical extract application 145 can be configured to respond to a query for computing resource usage data (hereinafter, “extraction query”) by providing (e.g., generating and transmitting) a data structure that is populated with the requested usage data (e.g., usage data that satisfy or match the query). The populated data structure can be provided to a requesting computing resource, such as investigating computing resource 115. In an example, the data structure can be a hierarchical data structure, such as a file system. Such data structure can be self-contained, such as enable the data structure to be communicated and a processed (e.g., read or analyzed) independently of any particular computing system or computing environment.

The historical extract application 145 can be configured to respond to an extraction query by analyzing one or more point in time backups to identify files that were created, accessed, modified, or deleted by a target user, or using a target computing resource, during a specified time window. In an example, such analysis can include retrieving (e.g., from the storage system 155 or the backup application 140) and processing each physical point in time backup that is associated with a target of the extraction query and that was created or stored within the time window. In another example, such analysis can include retrieving or processing an index or summary file that includes data that is useful for identifying files that were created, accessed, modified, or deleted by target user, or using target computing resource, during a specified time window. In another example, such analysis can include accessing a database of metadata to retrieve metadata this is indicative of forensic file events that were captured by the target computing resource, or in association with operations performed by a target user, within the specified window of time.

The computing resource usage data can include any data that is indicative of information that was accessible, or accessed, by the target user or target computing resource during a specified time window, as described herein. In an example, the historical computing resource data includes a copy of any user-level or system-level file that was accessed by the target user or target computing resource. In such an example, a filtering criteria can be used to determine whether such user-level or system-level file is included computing resource data that is returned to the requesting computing resource. The filtering criteria can, for example, limit the included files to those files that were created, read, modified, or deleted during the specified window of time.

In an example, the computing resource usage data can include a physical copy of file system objects that was newly created during the specified window of time. Such file system objects can be retrieved from the storage system 155, such as through use of the backup application 140, and provided in a response to the query.

In another example, the computing resource usage data can include physical copies of two or more versions of a file system object that was modified during the specified time widow. As an example, when a file or other filesystem object is modified during the specified window of time, a first version of the file that was preserved in a first point in time backup before the modification and a second version of the file that was preserved in a second point in time backup after the modification can provided in response to an extraction query. Each version of the modified file object (e.g., the first version and the second version of the file in the previous example) can be temporally flattened and stored in the same partition (e.g., directory or folder) of a hierarchical data structure, as described herein. Such temporal flatting of the different versions of the file system object include modifying an identifier of each version of the file system object, such as to cause a first version of the file system object to have a different identifier than the second version of the file system object. In an example, each identifier can be augmented to include a version indicator, such as a version number or a date that a version of the file system object was created.

In another example, the computing resource usage data can include file system objects that were deleted during a time window that is specified in an extraction query. In such an example, the historical extract application 145 can retrieve, such as from the storage system 155, a version of the deleted file system object that was preserved prior to the deletion. The preserved version of the deleted file system object can be provided in a response to the extraction query. In some examples, an identifier of the preserved version of the deleted file system object can be modified to indicate that the identifier is associated with, or identifies, a preserved version of a deleted file system object. In an example, such modification can include modifying the identifier to include the term “deleted” along with other information associated with the deletion, such as a date of the deletion.

In another example, the computing resource usage data can include metadata that is generated by the historical extract application 145, the backup server 135, or a forensic file service system, such as discussed in U.S. patent application Ser. No. 16/360,273. Such metadata can be included in the computing resource usage data to enhance or enrich one or more versions of the previously discussed file systems objects. Such metadata can include information that is useful for determining the provenance of a version of a file system object that was deleted or modified within the time window specified in an extraction query. In an example, when the an identifier (e.g., a file name) of one or more preserved versions of a file is modified to enable two or more versions of the file to be stored the same storage partition (e.g., directory) of the hierarchical data structure, the historical extract application 145 can generate, or provide, metadata that includes the original file name and directory of the modified file, an indicator of a forensic file event or operation that is associated with the modification of the file, or a hash value or other security or data integrity value. The historical extract application 145 can also generate, or provide, an identifier of a user that caused the modification, a date of the modification, a modification version number, or any other information that can be useful to an investigator. Similar metadata can be generated for deleted files or file system objects.

In another example, the computing resource usage data can include analytical information that is derived from the retrieved historical computing resource data. Such analytical information can include a summary of the retrieved computing resource usage data, such as to indicate names and types of file system objects that are included in the usage data. Such summary can include, for example, a listing of file system objects that were active (e.g., in use), synchronized, or shared within a time window specified in an extraction query. Such summary can also include a listing of file system object archives, secured file system objects, or executable file system objects. Such analytical information can also include automatically generated data or information that is indicative of insights derived from the computing resource usage data. The computing resource usage data, for example, can include data that highlights, or identifies, file system objects that can be of particular interest to an investigator, such as file system objects (e.g., executable file system objects) that are potential security risks.

Other examples of historical computing resource data include system records (e.g., system registry entries), extracted or flattened archives, or forensic file events.

The investigating computing resource 115 can include any computing system or endpoint device, such as a user computing device, computing server, or a network-based or hosted computing environment. Such computing resources can be configured (e.g., programmed) with one or more application to issue an extraction query to the backup server 135, such as though electronic communication with the historical extract application 145 over the network 150, for historical computing resource data, as described herein. The investigating computing resource 115 can also be configured to receive, from the backup server 135, data structure that is populated with temporally flat computing resource data (e.g., target extracts 120) that satisfies the extraction query. The data structure can be store in, and processed from, a storage component 125. The storage component 125 can include any storage device or storage system, such as a hard disk, solid-state drive, or a cloud or network-based storage system.

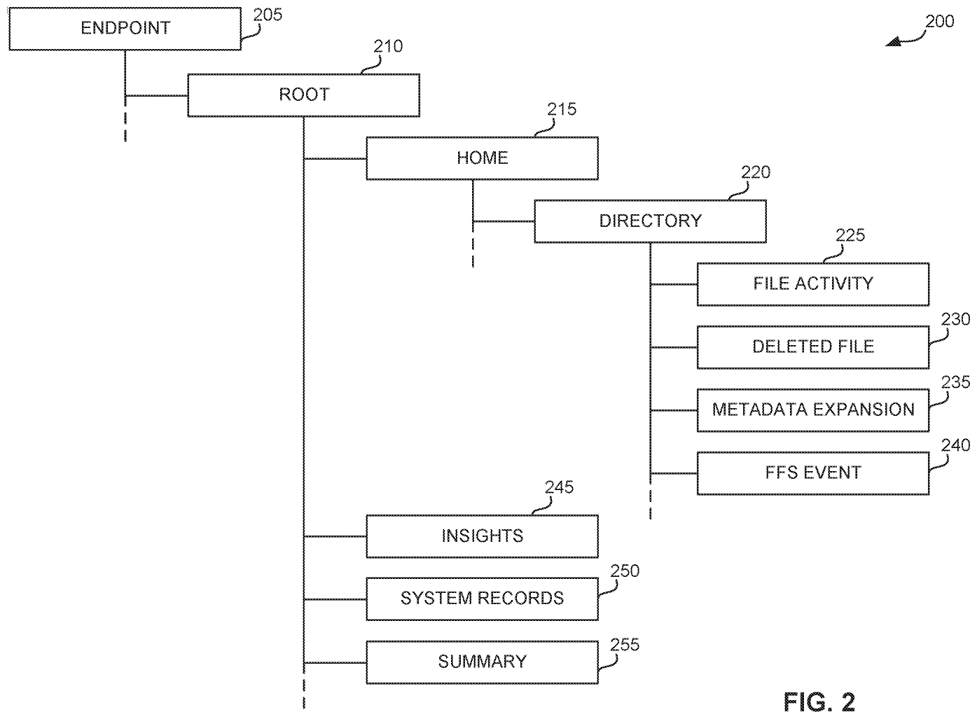

FIG. 2 illustrates block diagram of an example of elements of data structure 200 for storing computing resource usage data, according to some examples of the present disclosure. The data structure 200 can be an example of a data structure generated by the historical extraction application 145 (FIG. 1) and populated with computing resource usage data that match or satisfy a query for computing resource usage data for a target during an indicated window of time. In an example, the data structure 200 is a hierarchical data structure that is configured to store data objects in one or more hierarchically linked storage partitions. In another example, the data structure 200 is a file system data structure and the one or more hierarchically linked storage partitions is a filesystem director or folder.

A first level of the data structure 200 can include one or more endpoint partition 205, such as to store computing resource usage data from an indicated endpoint device or computing resource. The endpoint can include any computing resource that is associated with, or that contains, computing resource usage data that satisfies an extraction query, such as discussed in FIG. 1. In an example, the data structure 200 can include one or more endpoint partitions when an extraction includes a target user and such user had accessed to data on one or more disparate endpoints or computing resources during a specified time window.

Another level of the data structure 200 can include one or more root partitions 210, such as to operate or serve as the highest level partition of a data file system structure of a partition of a storage resource of an endpoint or computing resource. In an example, the root partition 210 can be the highest folder or directory of a partition of storage system, such as a hard disk drive, a solid-state drive, or a cloud or network-based storage. The root partition 210 can include a home partition 215, an insights partition 245, a system records partition 250, a summary partition 255, or any other useful partitions for storing computing resource usage data that satisfy an extraction query.

The home partition 215 can include file system objects that are created, owned, or modified by a particular user. In an example, the home partition 215 can include one or more directory partitions 220. The directory partition 220 or the home partition 215 can include one or more file activity object 225, deleted file system objects 230, metadata expansion objects 235, or forensic file service event objects 240.

The file activity objects 225 can include one or more versions of a file system object that was created or modified by a target of an extraction query during a specified time window. Such file activity objects 225 can be stored in a temporally flat format, as described herein.

The deleted file object 230 can include one or more file system objects that were deleted by a target of an extraction query during a specified time window. In an example, the deleted file system object 230 can include a version of a deleted file system object that was preserved prior to the deletion, as described herein.

In an example, the file activity objects 225 or the deleted file object 230 can include a compressed archive or one or more files that were expanded from a compressed archive.

The metadata expansion object 235 can include one or more file system objects that include metadata associated with file activity object 225 or deleted file object 230. Such metadata can be generated by the backup server 135 (e.g., the historical extraction application 145) and can include any information that is useful to enhance the description, presentation, or analysis of file activity object 225 or deleted file object 230. In an example, for each version of a modified file system object that satisfies an extraction query, the metadata expansion object 235 can include an original identifier of the modified file system object, an identifier of the owner of the file system object, a data integrity value (e.g., an MD5 hash), and any other useful attribute of the original or modified version of the file system object. In another example, the metadata expansion object 235 can include metadata that is associated with expanded archives.

Forensic file service event object 240 can include one or more file system objects that include information that is indicative of events or operations associated with the creation, deletion, modification, or processing of a file system object during a specified time window. Such events or operations can include accessing or transferring a file system object to an external storage device, transmitting or uploading a file system object over data communication network, executing screen capture, printing a file system object, changing an identifier or location of a file system object, processing a file system object using an indicated software application, or any other event or operation that is useful for responding to the extraction query.

Insights partition 245 can include one or more file system objects that include analytical information that is derived from the computing resource usage data that match or satisfy an extraction query. In an example, insights partition 245 can include one or more copies of, or links to, files that may be of interest to an investigator (e.g., as user of the investigative computing resource 115), such as file system objects are possible security risks (e.g., executable files) or file system objects that include data this is protected by, or valuable to, an organization. In another example, the insights partition 245 can include data that affects the presentation of such file system objects, such as by highlighting, or otherwise identifying, file system objects that satisfy a specified risk or value criteria. Such security risk or value criteria can include an indicated level of security or pecuniary interest associated with a specified type of file system object, an amount of activity associated with file system object during a time window, or a type of activity associated with a file system object.

System records element 250 can include one or more versions of a file system object that include system level information that was created, modified, or processed, by a target of an extraction query during a specified time window. Such system information can include one or more binary large objects having system registry data or device driver data.

Summary partition 255 can include one or more file system objects that include information that summaries the computing resource usage data that match an extraction query. The summary 255 can include, for example, a listing of all file system objects that were active (e.g., in use), synchronized, or shared within a specified time window. Such summary can also include a listing of file system object archives, secured file system objects (or archives), or executable file system objects, as described herein.

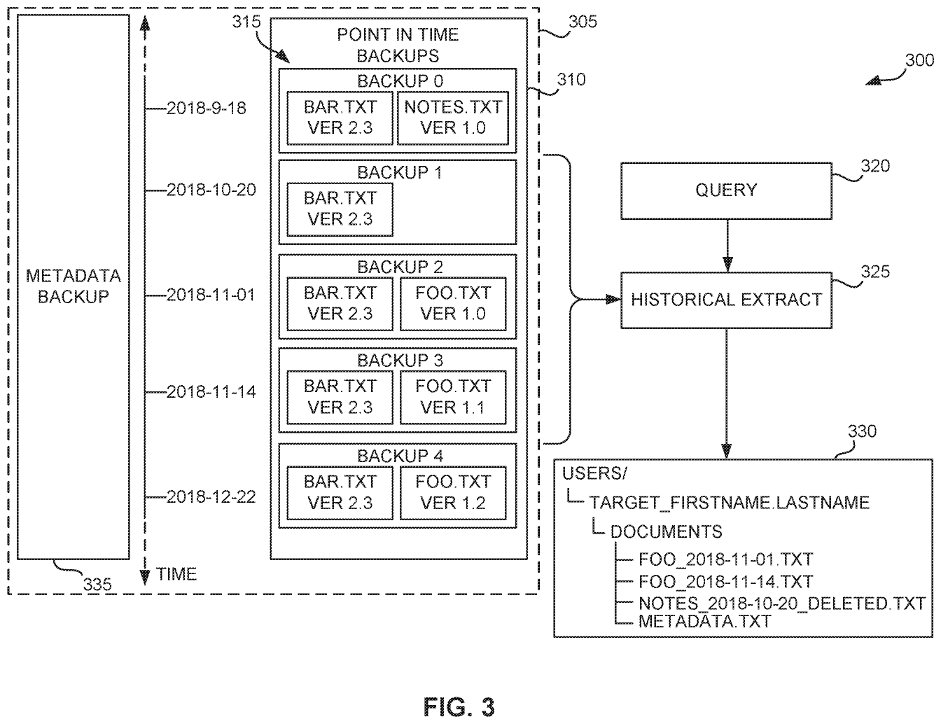

FIG. 3 illustrates a block diagram of an example of components of a system 300 for generating computing resource usage data for a target user or computing resource, according to some examples of the present disclosure. The system 300 can be an example of the system 100 (FIG. 1) and can include a storage system 305 and a backup server having a historical extract application or service 325 (hereinafter, “historical application 325”).

The storage system 305 can be an example of the storage system 155 (FIG. 1) and can include a point in time backup repository 310 and a metadata backup repository 335. The point in time backup repository 310 can include one or more point in time backups 315 that were received from one or more computing resources, such as computing resource 105 or 110, as shown in FIG. 1. In an example, the point in time backups 315 can be generated at specified times, such as indicated in FIG. 3. The metadata backup repository 335 can include any metadata is associated with the computing resources 105 or 110, as described herein. Such metadata can be generated by the computing resources 105 or 110, the backup server 135 (FIG. 1), a forensic file service system, or any other computing resource.

The historical extract application 325 can be an example of the historical extract application 145 (FIG. 1). The historical application 325 can receive an extraction query 320 for extracting, from the storage system 305, computing resource usage data of a target during a specified window of time. The extraction query 320 can include, in addition to the target and the specified window of time, one or more other selection criteria, such as requested file paths, an endpoint or computing resource whose backups should be processed, a maximum number of versions of a single file system object to consider or report, or a maximum size of the total extracted computing resource usage data. The extraction query 320 can also include one or more specifications or instructions for processing or reporting archives, file stubs, or binary large objects. The historical extract application 325 can process the extraction query 320 by extracting, such as from point in time backups 315 or metadata backup repository 335, computing resource usage data that satisfy criteria or conditions specified in the query. The historical extract application 325 can then modify the extracted computing resource usage data and provide the modified data in a data structure 330, such the data structure 200 (FIG. 2).

In an example, the extraction query 320 can include a query to extract computing resource usage data that was generated by a target during a two month period from Oct. 1, 2018 to Nov. 31, 2018. The historical extract application 325 can analyze the point in time backups 315 (e.g., backup 1, backup 2, and backup 3) and the metadata backup repository 335 to identify and extract backup data that match or satisfy the extraction query. The extracted data can then be modified and provided in the data structure 330. In an example, the file foo.txt was created and modified within the specified window of time. The historical extract application 325 can extract the original version and the modified version of foo.txt (e.g., from backup 2 and backup 3, respectively), modify an identifier of each version of the extracted file (e.g., to temporally flatten the extracted files), and store a copy of each version with the modified identifier in the data structure 320. In another example, the file notes.txt was deleted during the specified window of time, such as indicated by backup 0 and backup 1. The historical extract application 325 can extract the most recently preserved copy of notes.txt before the deletion, modify the file to indicate that is was deleted, and provide the modified file in the data structure 330. In these examples, the historical extract application 325 can generate the file system object metadata.txt to include metadata associated with the extracted versions of foo.txt or the notes.txt, as described herein.

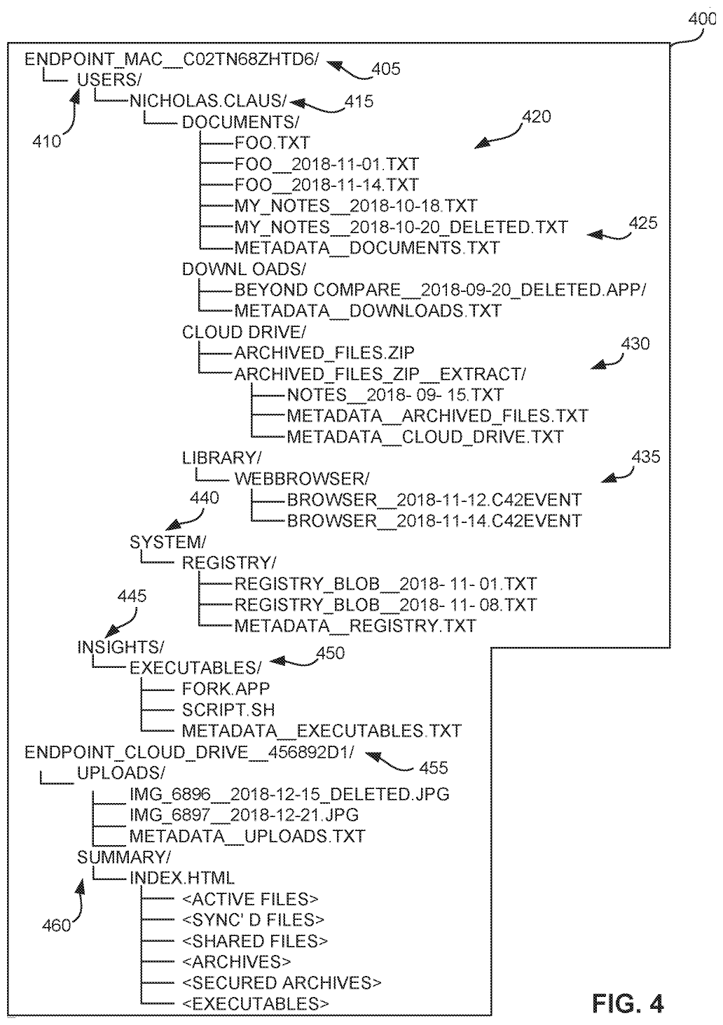

FIG. 4 illustrates an example of an implementation of a data structure 400 for storing computing resource usage data, according to some examples of the present disclosure. The data structure 400 can be an example of the data structure 200 (FIG. 2) or an expanded version of the data structure 330 (FIG. 3). At a first level, the data structure 400 includes endpoint partition 405 and 455, which are associated with an endpoint computing device and a cloud or network based storage system, respectively. The endpoint partition 405 includes a root partition 410 that is associated with a partition of the endpoint storage system device that is allocated for users. The root partition 410 includes a home partition 415 that is associated with, or owned by, a user, such as a target of an extraction query. The home partition 415 includes copies of versions of files 420 that were created, modified, deleted, or processed during a time window specified in an extraction query. The home partition 415 also include a metadata file 425 having extracted or generated metadata that is associated with files 420. The home partition 415 also includes the extracted contents of an archive file 430 and associated metadata. The home partition 415 also includes files storing forensic file system events 435, such as events captured from a web browser. The endpoint partition 405 also includes a system partition 440 that stores one or more temporally flattened versions of a registry BLOB and associated metadata. The endpoint partition 405 further includes an insights partition 445 that is populated with copies of, or links to, files, such as executable files 450, that are identified as being a security risk.

The data structure 400 can also include a summary partition 460 that stores a summary of the contents of the of the data structure, as described herein.

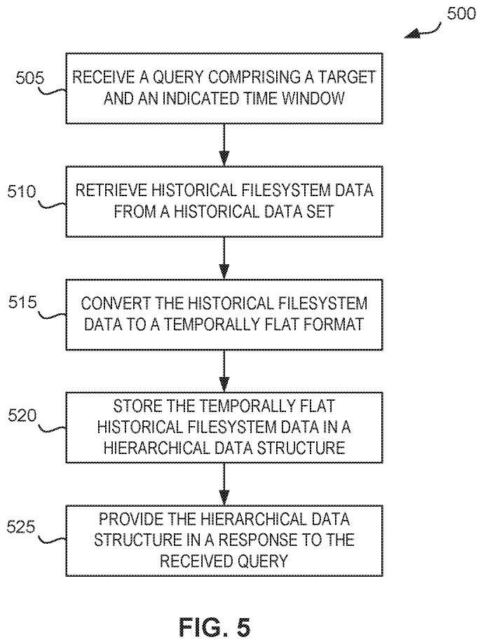

FIG. 5 illustrates an example of a process 500 for generating computing resource usage data of a target user or a target computing resource, according to some examples of the present disclosure. The process 500 can be executed by any of the systems described in the discussion of FIGS. 1-4. In an example, the process 500 is executed by a historical extract application, such as the historical extract application 145 (FIG. 1) or 325 (FIG. 3). The process 500 can be executed to extract computing resource usage data of a target user or a target computing resource from a one or more point in time backups within a specified window of time. At 505, a query for extracting the computing resource usage data can be received. The query can include a target user or a target computing resource and a specified time window (e.g., a period of time for which computing resource usage data can be considered or extracted). At 510, file system data that satisfies the query can be retrieved from a historical dataset, such as a metadata backup repository or point in time backup repository. Such file system data can include copies of file system objects that were created, modified, deleted, or processed during the specified time window. Such file system data can also include preserved metadata or new metadata that is generated from the retrieved file system data, as described herein. At 515, historical usage data can be generated by converted the retrieved file system data to a temporally flat format (e.g., the file system data can be modified or enhanced to generate temporally flat file system data, as described herein) while preserving the provenance of file system objects included in the file system data. At 520, a data structure, such as a filesystem data structure or other hierarchical data structure, can be populated with the temporally flat historical file system data. At 525, the populated data structure can be provided in response to the extraction query.

The process 500 can include any other steps or operations for implementing the techniques described herein.

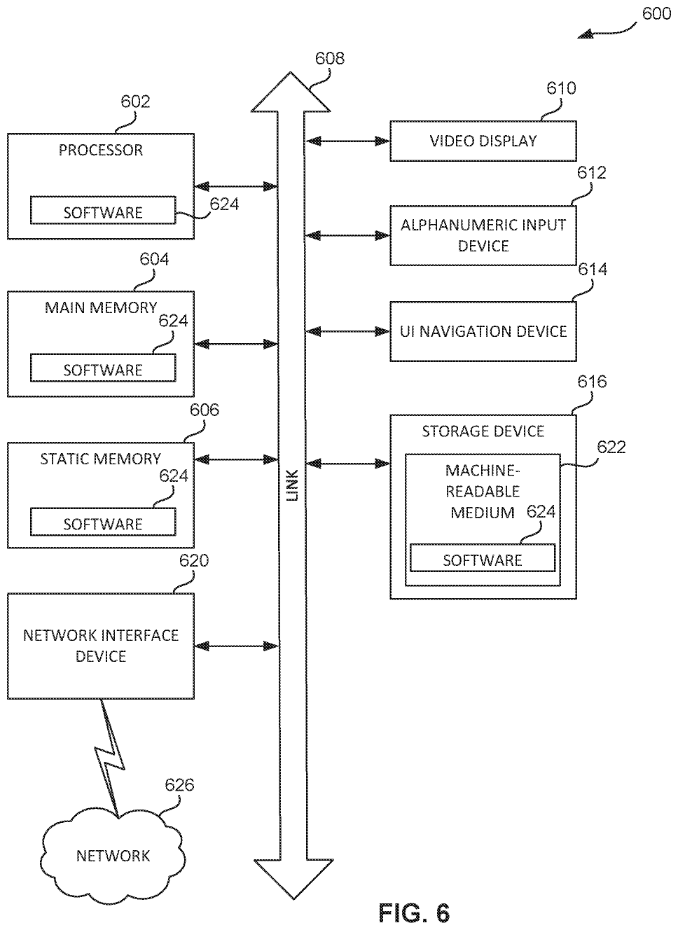

FIG. 6 illustrates a diagrammatic representation of a machine in the form of a computer system within which a set of instructions may be executed for causing the machine to perform any one or more of the methodologies discussed herein, according to an example. The computer system 600 can be an example of the any of the backup server or computing resources discussed herein.

In alternative examples, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one example, the video display unit 610, input device 612 and UI navigation device 614 are incorporated into a touch screen display. The computer system 600 may additionally include a storage device 616 (e.g., a drive unit), such as a global positioning system (GPS) sensor, compass, accelerometer, gyrometer, magnetometer, or other sensor.

The storage device 616 includes a machine-readable medium 622 on which is stored one or more sets of data structures and instructions 624 (e.g., software) embodying or utilized by any one or more of the methodologies or functions described herein. In an example, the one or more instructions 624 can include an historical extract application or service, or a backup/restore server or client application, as described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example example to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the—readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any example herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any example herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some examples, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some examples, the processor circuitry may be embodied as a stand-alone integrated circuit or may be incorporated as one of several components on an integrated circuit. In some examples, the various components and circuitry of the node or other systems may be combined in a SoC architecture.

The above detailed description includes references to the accompanying drawings, which form a part of the detailed description. The drawings show, by way of illustration, specific examples that may be practiced. These examples are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other examples may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as examples may feature a subset of said features. Further, examples may include fewer features than those disclosed in a particular example. Thus, the following claims are hereby incorporated into the Detailed Description, with a claim standing on its own as a separate example. The scope of the examples disclosed herein is to be determined with reference to the appended claims, along with the full scope of equivalents to which such claims are entitled.

What is claimed is:

1. A system to generate historical usage data of a computing resource, the system comprising:
a module is configured to use at least one processor of the system to:
receive a query comprising a target and a time window;
retrieve historical file system data from backups of computing resources, the historical file system data comprising a file system object that was processed by the target during the time window;
generate historical usage data by converting the historical file system data to a temporally flat format that preserves a provenance of the file system object;
store the historical usage in a hierarchical data structure; and
provide the hierarchical data structure in a response to the received query.

2. The system of claim 1, wherein the target comprises a computing resource or a user of the computing resource.

3. The system of claim 1, wherein the file system object was created, modified, or deleted during the time window.

4. The system of claim 1, wherein the historical file system data further comprises at two or more versions of the file system object, wherein at least one version of the two or more versions of the file system object was modified during the time window.

5. The system of claim 1, wherein the historical file system data comprises metadata that is indicative of a file system event that was generated during the time window.

6. The system of claim 1, wherein to convert the historical file system data to the temporally flat format, the module is further configured to use at least one processor of the system to:
retrieve a first version of the file system object from the historical file system data;
retrieve a second version of the file system object from the historical file system data; and
modify the first version of the file system object and the second version of the file system object to distinguish the first version of the file system object from the second version of the file system object when each version is stored concurrently in a same partition of the hierarchical data structure.

7. The system of claim 6, wherein to convert the historical file system data to a temporally flat format that preserves the provenance of the file system object, the module further configured to use at least one processor of the system to generate a file system object comprising metadata that useful to determine the provenance of the file system object.

8. The system of claim 7, wherein the metadata comprises an original identifier of the file system object.

9. The system of claim 1, wherein the hierarchical data structure comprises a file system data structure of one or more computing resource.

10. The system of claim 1, wherein a hierarchy of the hierarchical data structure does not depend on a time.

11. The system of claim 1, the historical file system data comprises data operated on or generated by the target within the time window.

12. The system of claim 1, wherein storing the temporally flat historical file system data in a hierarchical data structure comprises:
determining that the file system object satisfies an indicated criteria; and
enhancing an indicator of the file system object in the hierarchical data structure to indicate that the data object satisfies the indicated criteria.

13. A method for generating historical usage data of a computing resource, the method comprising:
receiving a query comprising a target and a time window;
retrieving historical file system data from backups of computing resources, the historical file system data comprising a file system object that was processed by the target during the time window;
generating historical usage data by converting the historical file system data to a temporally flat format that preserves a provenance of the file system object;
storing the historical usage in a hierarchical data structure; and
providing the hierarchical data structure in a response to the received query.

14. The method of claim 13, wherein the target comprises a computing resource or a user of the computing resource.

15. The method of claim 13, wherein the file system object was created, modified, or deleted during the time window.

16. The method of claim 13, wherein the historical file system data comprises metadata that is indicative of a file system event that was generated during the time window.

17. The method of claim 13, wherein converting the historical file system data to the temporally flat format comprises:
retrieving a first version of the file system object from the historical file system data;
retrieving a second version of the file system object from the historical file system data; and
modifying the first version of the file system object and the second version of the file system object to distinguish the first version of the file system object from the second version of the file system object when each version is stored concurrently in a same partition of the hierarchical data structure.

18. The method of claim 17, wherein converting the historical file system data to a temporally flat format that preserves the provenance of the file system object comprises generating a file system object comprising metadata that useful to determine the provenance of the file system object.

19. A non-transitory machine-readable medium comprising instructions, which when executed by a machine, causes the machine to perform operations comprising:
receiving a query comprising a target and a time window;
retrieving historical file system data from backups of computing resources, the historical file system data comprising a file system object that was processed by the target during the time window;
generating historical usage data by converting the historical file system data to a temporally flat format that preserves a provenance of the file system object;
storing the historical usage in a hierarchical data structure; and
providing the hierarchical data structure in a response to the received query.

20. The non-transitory machine-readable medium of claim 19, wherein converting the historical file system data to the temporally flat format comprises:
retrieving a first version of the file system object from the historical file system data;
retrieving a second version of the file system object from the historical file system data; and
modifying the first version of the file system object and the second version of the file system object to distinguish the first version of the file system object from the second version of the file system object when each version is stored concurrently in a same partition of the hierarchical data structure.
